(19) United States
(12) Patent Application Publication
(10) Pub. No.: US 2021/0165921 A1
(43) Pub. Date: Jun. 3, 2021

(54) Method for Designing a Multimodal Energy System and Multimodal Energy System

(71) Applicant: Siemens Aktiengesellschaft, München (DE)

(72) Inventors: Martin Kautz, Erlangen (DE); Jochen Schäfer, Nürnberg (DE); Sebastian Thiem, Neustadt an der Aisch (DE)

(73) Assignee: Siemens Aktiengesellschaft, München (DE)

(21) Appl. No.: 16/770,695

(22) PCT Filed: Nov. 6, 2018
(86) PCT No.: PCT/EP2018/080269

§ 371 Date: Jun. 8, 2020

(30) Foreign Application Priority Data
Dec. 7, 2017 (DE) 10 2017 222 131.3

(51) Int. Cl. G06F 30/10; G06Q 10/04

(52) U.S. Cl. CPC G06F 30/10; G06F 2113/04; G06Q 10/04

(57) ABSTRACT

Various embodiments include a method for designing a multimodal energy system having a plurality of components comprising: providing a first plurality of parameters; stipulating a second plurality of secondary conditions; stipulating a target function; defining a critical operating state of the multimodal energy system; and extremalizing the target function on the basis of the first plurality of parameters, the second plurality of secondary conditions, and the critical operating state using an optimization method.

### CROSS-REFERENCE TO RELATED APPLICATIONS

This application is a U.S. National Stage Application of International Application No. PCT/EP2018/080269 filed Nov. 6, 2018, which designates the United States of America, and claims priority to DE Application No. 10 2017 222 131.3 filed Dec. 7, 2017, the contents of which are hereby incorporated by reference in their entirety.

### TECHNICAL FIELD

The present disclosure relates to multimodal energy systems. Various embodiments may include methods for designing a multimodal energy system having a plurality of components and/or multimodal energy systems having a plurality of components.

### BACKGROUND

Multimodal energy systems provide at least one form of energy for an energy consumer, for example a building, an industrial installation or private installations, said provision including a conversion of various forms of energy, by means of a transportation of various forms of energy and/or by means of stored forms of energy. In other words, the various forms of energy, for example heat, cold or electric power, are coupled by means of the multimodal energy system in terms of their generation, their provision and/or their storage. Failure of the multimodal energy system and hence the provision of the forms of energy is typically not tolerable in this instance.

It is therefore advantageous if the multimodal energy system has resilience, or is considered robust. In this disclosure, the term resilience refers to the ability of the multimodal energy system to not fail completely in the event of perturbations, partial failures, and/or disruptive events, but rather to maintain essential system services, for example the provision of heat, cold or electric power. Failures or perturbations can be triggered by internal or external events with reference to the multimodal energy system. By way of example, a disruptive event can be a power failure, a hacker attack on pumps of a district heating network, a failure of cogeneration installations or the like.

Typically, multimodal energy systems have a specific level of resilience as a result of redundant components. However, this redundancy is added manually after the multimodal energy system is designed. Therefore, known multimodal energy systems are typically oversized to achieve resilience. This oversizing may be referred to as a fear factor.

If the multimodal energy system is designed in as optimum a fashion as possible by means of a known energy system design method, for example, then subsequent manual oversizing is likewise performed to provide redundancy. After redundancies are added, the multimodal energy system differs from its optimum design determined by means of the known energy system design method, which means that the most optimum operation possible is no longer a certainty. Furthermore, the security of supply by the multimodal energy system is not necessarily a certainty, since possible failure scenarios were not considered when forming the redundancies.

### SUMMARY

The teachings of the present disclosure include methods for designing a multimodal energy system that leads to an improved resilience for the multimodal energy system. For example, some embodiments include a method for designing a multimodal energy system having a plurality of components, comprising the steps of: providing a plurality of parameters; stipulating a plurality of secondary conditions; stipulating at least one target function; characterized by stipulating at least one critical operating state (42) of the multimodal energy system; and extremalizing the at least one target function on the basis of the parameters, the secondary conditions and the at least one critical operating state (42) by means of an optimization method.

In some embodiments, the at least one critical operating state (42) is taken into consideration when stipulating the parameters and/or when stipulating the secondary conditions and/or when stipulating the target function.

In some embodiments, the parameters used are an energy price and/or a load profile and/or weather data and/or a generability of renewable energies.

In some embodiments, the parameters have a time dependency, wherein the time dependency thereof over a first period (40), in particular over one year, is taken into consideration for the optimization method.

In some embodiments, the target function used is the operating costs of the multimodal energy system and/or the carbon dioxide emission of the multimodal energy system and/or the primary energy use of the multimodal energy system.

In some embodiments, the critical operating state (42) stipulated is a power failure and/or a heat failure and/or a cold failure and/or a failure of an energy transfer line and/or a failure of a component of the multimodal energy system.

In some embodiments, parameters characterizing the critical operating state (42) are provided.

In some embodiments, the characterizing parameters used are weather data and/or an availability of energy transfer lines and/or an availability of renewable energy generation and/or a minimum capacity of an energy store and/or a proportional energy requirement in relation to an energy peak load.

In some embodiments, a plurality of critical operating states (42) are taken into consideration by means of the optimization method when extremalizing the target function, wherein the critical operating states (42) are weighted in accordance with their frequency and/or relevance.

In some embodiments, monitoring data of a comparable multimodal energy system are used for stipulating the at least one critical operating state (42).

In some embodiments, the monitoring data are used to ascertain a plurality of critical operating states (42), wherein at least one subset of the ascertained critical operating states (42) that is stipulated in accordance with the frequency of occurrence of the ascertained critical operating states (42) is taken into consideration for the optimization method.

In some embodiments, the monitoring data are provided by means of a computer cloud.

As another example, some embodiments include a multimodal energy system having a plurality of components, characterized in that the multimodal energy system is designed by means of a method as described above.

In some embodiments, it comprises a monitoring system for capturing monitoring data, in particular load profiles and/or critical operating states (42).

In some embodiments, the monitoring system is connected to a computer cloud for the purpose of interchanging data, in particular for the purpose of interchanging the monitoring data.

### BRIEF DESCRIPTION OF THE DRAWINGS

Further advantages, features, and details of the teachings herein are discussed in relation to the exemplary embodiments described below and with reference to the drawings, in which, schematically:

FIG. 1 shows a design of a multimodal energy system by means of an energy system design method in accordance with the prior art; and

FIG. 2 shows a design of a multimodal energy system incorporating teachings of the present disclosure.

Elements that are of the same type, equivalent or that have the same effect can be provided with the same reference signs in one of the figures or in the figures.

### DETAILED DESCRIPTION

In some embodiments, the teachings herein provide methodsfor designing a multimodal energy system having a plurality of components comprising the following steps:
providing a plurality of parameters;
stipulating a plurality of secondary conditions;
stipulating at least one target function;
stipulating at least one critical operating state of the multimodal energy system; and
extremalizing the at least one target function on the basis of the parameters, the secondary conditions, and the at least one critical operating state by means of an optimization method.

The “design” of a multimodal energy system refers to its structure and/or its arrangement in respect of its components, the sizing thereof, and/or the economic efficiency analysis thereof. The most optimum possible or optimum design of the multimodal energy system is likewise referred to as the optimization problem. A result of the optimization method is the design of the multimodal energy system, that is to say for example its structure, its sizing, its economic efficiency analysis, and/or the like.

The components of the multimodal energy system may comprise: one or more power generators, cogeneration installations, in particular cogeneration units, gas boilers, diesel generators, heat pumps, compression refrigeration machines, absorption refrigeration machines, pumps, district heating networks, energy transfer lines, wind turbines or wind power installations, photovoltaic installations, biomass installations, biogas installations, waste incineration installations, industrial installations, conventional power stations and/or the like. The provided parameters can be referred to as input parameters. Furthermore, the secondary conditions can be specific boundary conditions and/or constraints that need to be satisfied.

The optimization method is a mathematical and/or numerical optimization method, for example, performed by means of a computing apparatus, for example. The critical operating state can be referred to as a critical scenario or failure scenario. In some embodiments, the target function is extremalized. In other words, the target function is minimized or maximized if possible. The value determined in this manner, and therefore optimum, for the target function is referred to as a target value. It is not necessary for the target function to be exactly at a minimum or maximum, but rather it is sufficient if a best possible target value can be ascertained that is sufficiently close to the minimum or maximum. In other words, it can be sufficient to extremalize the target function approximately.

An operating state of the multimodal energy system can be denoted as critical if at least the provision of a form of energy by the multimodal energy system is jeopardized, limited, or no longer made. By way of example, partial or complete failure of at least one component of the multimodal energy system is a critical operating state.

In some embodiments, the target function is extremalized on the basis of the parameters, the secondary conditions, and the at least one critical operating state by means of the optimization method. In some embodiments, a plurality of critical operating states may be taken into consideration. In other words, the at least one critical operating state of the multimodal energy system is already taken into consideration when extremalizing the target function. In other words, the at least one critical operating state is part of the optimization problem and hence of the optimization method. As a result, a known energy system design method for designing the multimodal energy system in optimum fashion is performed in part, wherein, in contrast to the known energy system design method, the critical operating state of the multimodal energy system is taken into consideration when extremalizing the target function. This advantageously obviates the need for subsequent manual introduction of redundancies for providing a resilience for the multimodal energy system—as provided for in the prior art.

In some embodiments, the critical operating state and hence the resilience of the multimodal energy system toward the occurrence or appearance of the critical operating state is also taken into consideration from the outset when designing the multimodal energy system by means of an energy system design method. In some embodiments, a multimodal energy system that is as optimized and resilient as possible is provided as a result. Known energy system design methods do not have optimum resilience, since they do not take into consideration critical operating states.

In some embodiments, a resilient multimodal energy system is as optimized as possible in terms of cost. In some embodiments, the critical operating state of the multimodal energy system is taken into consideration for the optimization method implicitly and in parallel. This allows a guarantee to be provided for the critical operating state taken into consideration. Furthermore, the supply of energy by the multimodal energy system designed according to the teachings herein or the provision of forms of energy by means of the multimodal energy system can be ensured even when the critical operating state occurs (resilience).

In some embodiments, the components of the multimodal energy system are determined or determinable by means of the design thereof. By way of example, additional components are required for a form of energy in order to provide the resilience. These additional components can furthermore be used to make full use of or cover a peak load. In some embodiments, this allows additional investment to be avoided. In other words, synergistic effects are obtained between the provision of forms of energy by means of the coupled components of the multimodal energy system and its resilience, which are made possible by means of the methods incorporating teachings of the present disclosure.

Various energy system design methods, that is to say the most optimum possible design of the multimodal energy system with reference to the stipulated target function, are expanded by a contemplation of the resilience that is produced here as a result of the at least one critical operating state being taken into consideration. In some embodiments, the optimization problem is therefore integrally formulated.

In some embodiments, the at least one critical operating state is taken into consideration when stipulating the parameters and/or when stipulating the secondary conditions and/or when stipulating the target function. In some embodiments, this results in the critical operating state being taken into consideration at different points in the optimization method. In some embodiments, this results in an improved resilience for the designed multimodal energy system.

In some embodiments, the parameters used are an energy price and/or a load profile and/or weather data and/or a generability of renewable energies. At least some of the parameters are provided for defining or establishing the optimization problem. In this case, the aforementioned parameters are advantageous because they allow improved design of the multimodal energy system with reference to the target function.

In some embodiments, the parameters have a time dependency, wherein the time dependency thereof over a stipulated period, in particular over one year, is taken into consideration for the optimization method. In some embodiments, this improves the method for designing the multimodal energy system. This is the case because the parameters parameterize a load profile and/or weather data over one whole year, for example. Accordingly, the multimodal energy system can be optimized with reference to the load anticipable in one year, for example with reference to a thermal load, which can be dependent on weather data.

In some embodiments, the target function used is operating costs of the multimodal energy system and/or a carbon dioxide emission of the multimodal energy system and/or a primary energy use of the multimodal energy system. In some embodiments, this allows the operating costs, the carbon dioxide emission and/or the primary energy use of the multimodal energy system to be optimized, in particular minimized. By way of example, the carbon dioxide emission of the multimodal energy system is the target function.

In some embodiments, the critical operating state stipulated is a power failure and/or a heat failure and/or a cold failure and/or a failure of an energy transfer line and/or a failure of a component of the multimodal energy system. In other words, a power failure and/or a heat failure and/or a cold failure and/or a failure of an energy transfer line and/or a failure of a component of the multimodal energy system is taken into consideration when optimizing the target function and hence when designing the multimodal energy system.

The critical operating state is therefore denoted by a critical scenario, for example a power failure in one or more components of the multimodal energy system. Furthermore, an energy transfer line, that is to say a technical device for unidirectional or bidirectional conduction or forwarding or transport of at least one form of energy, for example heat, cold or electric power, can fail at least in part, in particular completely. A failure can be denoted by a disruptive event that acts on the multimodal energy system internally or externally with respect to the multimodal energy system.

In some embodiments, parameters characterizing the critical operating state are provided. In other words, the critical operating state of the multimodal energy system is depicted or parameterized by means of the characterizing parameters. This introduces the critical operating state initially, that is to say already when the optimization problem is parameterized.

In some embodiments, the characterizing parameters used for the critical operating state to be characteristic weather data and/or an availability of energy transfer lines and/or an availability of renewable energy generation and/or a minimum capacity of an energy store and/or a proportional energy requirement in relation to an energy peak load. This allows for example critical and possibly disruptive events, in particular gales and/or storms, to be taken into consideration as characterizing weather data when parameterizing the optimization problem.

In some embodiments, a plurality of critical operating states are taken into consideration by means of the optimization method when extremalizing the target function, wherein the critical operating states are weighted in accordance with their frequency and/or relevance. In some embodiments, this also takes into consideration the frequency of occurrence or appearance of a critical operating state, for example a frequently anticipable failure of a power grid, for the optimization method. This is taken into consideration by means of a higher weighting for more frequently occurring or appearing critical operating states. By way of example, the failure of a power grid is weighted more highly because this critical operating state occurs more frequently or has been denoted as more relevant.

Furthermore, the weighting makes it possible to prevent components that, although initially appearing to be cheaper, have low cost efficiency on account of their poor energy efficiency from being used for designing the multimodal energy system. By way of example, it prevents the multimodal energy system from being designed using a diesel generator with poor efficiency instead of a diesel generator with better efficiency or a battery. Furthermore, the weighting of the critical operating states allows an individual design for the modular energy system.

In some embodiments, the weighting of the critical operating states achieves a specific resilience for a stipulated use of the multimodal energy system can be compared against the required costs. In particular, the overall costs are compared against the specific resilience and already taken into consideration when stipulating the target function. By way of example, the resilience of an industrial installation, for example an aluminum hut, is rated differently than the resilience of a residential building. Furthermore, the relevance of the resilience can also be split specifically over the individual energy requirement load profiles of the multimodal energy system.

In some embodiments, monitoring data of a comparable multimodal energy system are used for stipulating the at least one critical operating state. In some embodiments, this allows the most probable critical operating states of the multimodal energy system, in regard to their occurrence or appearance, to be taken into consideration when designing said multimodal energy system, without the critical operating states being stipulated manually. In other words, the possible and possibly most frequent critical operating states are ascertained and provided from the monitoring data of the comparable multimodal energy system. This results in an objective and technically advantageous selection of the critical operating states of the multimodal energy system, which are taken into consideration when designing the multimodal energy system. In some embodiments, a plurality of comparable multimodal energy systems are monitored over a period of five years. The monitoring data ascertained thereby can be evaluated with reference to statistically significant critical operating states. The critical operating states ascertained or identified thereby can be taken into consideration for the optimization method in weighted fashion. This provides a statistically objective resilience for the multimodal energy system.

In this disclosure, the term comparable multimodal energy system can be interpreted broadly. By way of example, a multimodal energy system is already comparable if it has at least one identical component or a component whose technical function or effect is identical. However, it is advantageous to use multimodal energy systems that are similarly or comparably structured, that have comparable components, comparable load profiles and/or comparable loads, provide comparable forms of energy, and/or are exposed to comparable external influences, for example as a result of a comparable geographical location and/or comparable weather conditions, for the comparison.

In some embodiments, a plurality of critical operating states are ascertained by means of the monitoring data, wherein at least one subset of the ascertained critical operating states that is stipulated in accordance with the frequency of occurrence of the ascertained critical operating states is taken into consideration for the optimization method. In other words, the optimization method involves the critical operating states that have occurred most frequently being taken into consideration. This allows the optimization or the design of the multimodal energy system to be coordinated to the frequency of occurrence of a critical operating state. In some embodiments, this reduces the operating costs of the multimodal energy system. This is the case because the multimodal energy system is designed for the most probable critical operating states in as optimum a fashion as possible as a result of its design.

In some embodiments, the monitoring data are provided by means of a computer cloud. In some embodiments, an evaluation of the provided monitoring data, which does not take place locally at the site of the multimodal energy system owing to the computer cloud, for example, allows the most frequent critical operating states to be selected. In this instance, the selection can be made statistically and in automated fashion using the monitoring data provided by means of the computer cloud. In some embodiments, the computer cloud is in the form of MindSphere (tradename from Siemens) or comprises MindSphere or is connected to MindSphere for data interchange.

Monitoring of the designed multimodal energy system and coupling thereof to the computer cloud, in particular MindSphere, allows a multimodal energy system to be designed in integrally automated and optimized fashion, independently of manual steps. This provides a resilient multimodal energy system that is as optimized as possible.

The multimodal energy systems described herein have a plurality of components and are characterized in that it is designed by means of a method as described herein or one of its refinements. In some embodiments, this provides a resilient multimodal energy system that continues to be operational if a disruptive event to which the critical operating state taken into consideration for the multimodal energy system corresponds occurs, for example. In other words, the multimodal energy system has a resilience with reference to the critical operating state. Similar and equivalent advantages arise in relation to the aforementioned methods for designing the multimodal energy system.

In some embodiments, the multimodal energy system comprises a monitoring system for capturing monitoring data, in particular load profiles and/or critical operating states. In some embodiments, the monitoring system is connected to a computer cloud, in particular MindSphere, for the purpose of interchanging data, in particular for the purpose of interchanging the monitoring data. This allows critical operating states of the multimodal energy system that are ascertained by means of the monitoring data to be taken into consideration when designing further comparable multimodal energy systems. Furthermore, the monitored multimodal energy system can be adapted or designed anew or again on the basis of the ascertained critical operating states in accordance with the present invention or one of its refinements. In other words, this allows a type of evolution of multimodal energy systems with reference to their resilience.

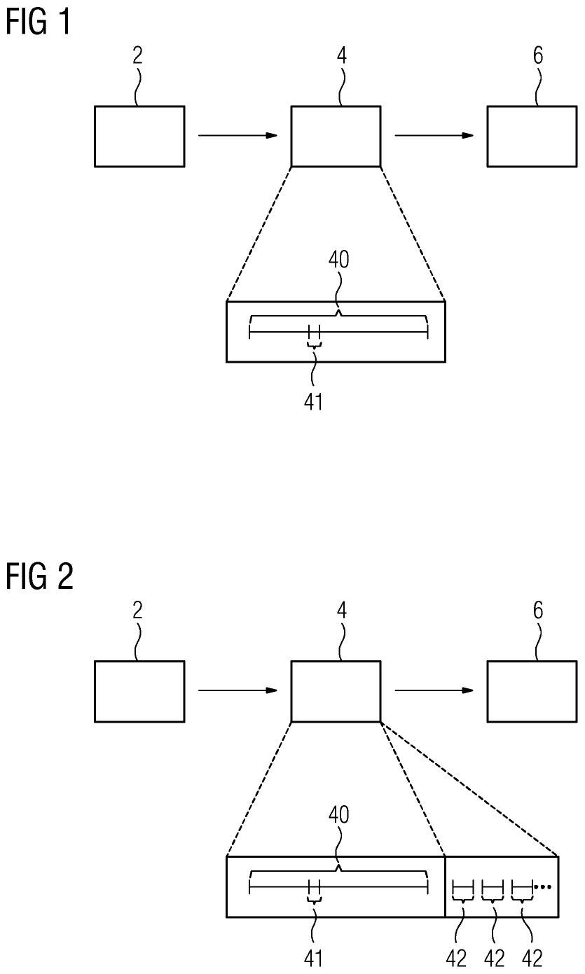

FIG. 1 shows a known energy system design method, that is to say a known method for designing a multimodal energy system. In a first step, denoted by the reference sign 2, a plurality of parameters, a plurality of secondary conditions, and a target function are provided or stipulated for the purpose of defining or developing the optimization method. In other words, the optimization problem is defined and parameterized by the parameters, the secondary conditions, and the target function.

In a further step, denoted by the reference sign 4, the optimization method takes place. This involves the target function being extremalized on the basis of or by taking into consideration the parameters and the secondary conditions. Typically, the target function is minimized. In other words, an extreme value (target value), typically a minimum, of the target function is ascertained, the secondary conditions likewise being met. The target function is extremalized by means of the optimization method, for example by means of a mathematical and/or numerical optimization method.

Typically, the parameters are time-dependent. This is taken into consideration by contemplating a first period 40, typically one year. By way of example, a load profile of a form of energy over one year is provided as a parameter. The first period 40 is furthermore divided into shorter second periods 41, for example one hour. The parameters and the secondary conditions are each regarded as constant within the shorter second periods 41. This results in a vector of parameters that, for one year, for example, has 8760 entries (number of hours in a year). This vector is used for the optimization method. The result of the optimization method is denoted by the reference sign 6. The result can be the design of the multimodal energy system and the target value of the target function.

FIG. 2 illustrates a method for designing a multimodal energy system in accordance with a refinement of the invention. In a first step, denoted by the reference sign 2, a plurality of parameters are provided and a plurality of secondary conditions and at least one target function are stipulated. There can be provision for a plurality of target functions. This defines or parameterizes the optimization problem.

In some embodiments, a critical operating state of the multimodal energy system is provided, which is taken into consideration for the optimization method. This can be accomplished by virtue of the critical operating state already being taken into consideration when providing the parameters, when stipulating the secondary condition and/or when stipulating the target function. By way of example, the parameters can be weather data matched to the critical operating state. In other words, the parameters comprise weather data characterizing the critical operating state.

In a further step, denoted by the reference sign 4, the optimization takes place, that is to say the extremalization of the target function by means of an optimization method, in particular by means of a mathematical and/or numerical optimization. This involves the optimization taking place on the basis of the parameters, the secondary conditions and, according to the invention, on the basis of the at least one critical operating state of the multimodal energy system.

The critical operating state can be stipulated manually. In some embodiments, the critical operating state or the critical operating states is/are stipulated in automated fashion. To this end, a statistic about the critical operating states that have occurred is determined for one or more comparable multimodal energy systems, for example. In other words, the critical operating states of comparable multimodal energy systems are weighted in respect of their relevance and/or their frequency of occurrence and, in weighted form, are taken into consideration for the optimization method and hence for the extremalization of the target function. This can involve the monitoring data being ascertained for the purpose of stipulating the relevant or frequent critical operating states by means of a computer cloud, in particular by means of MindSphere.

Once the at least one critical operating state of the multimodal energy system has been stipulated, it is taken into consideration for the optimization method in parallel with the further variables, that is to say in particular in parallel with the parameters and the secondary conditions. In other words, the optimization problem is integrally formulated and solved with reference to the resilience of the multimodal energy system.

In some embodiments, the parameters and/or secondary conditions are time-dependent, so that, again, a first period 40, in particular one year, is used for the purpose of contemplating the optimization problem. The first period 40 is divided into shorter second periods 41, for example one hour. One year can be represented by 8760 hours. Within the shorter second period 41, the parameters and/or secondary conditions are regarded as constant. Furthermore, the second period can be shorter than one hour, for example half an hour, a quarter of an hour or ten minutes.

The critical operating states are denoted by the reference sign 42 and can be appended to the first period 40, so that in this way they are optimized in parallel with the first period 40. By way of example, the critical operating states are represented by a vector having M entries. The first period 40, or the parameters and/or secondary conditions, is represented by a vector having N entries, wherein N=8760 for one year. The overall vector taken into consideration for the optimization method therefore has N+M, for example N+M>8760, entries. In this way, the critical operating states are taken into consideration in parallel with the first period 40. Alternatively or additionally, the critical operating states can occur or be taken into consideration within the first period 40.

In some embodiments, the method takes into consideration the at least one critical operating state when extremalizing the target function. This allows the subsequent manual introduction of a redundancy of the multimodal energy system to be avoided. In other words, a design that is as optimum as possible can be achieved by taking into consideration the critical operating state. Furthermore, a resilience, in particular a resilience that is as optimum as possible with reference to the critical operating state, for the multimodal energy system can be provided by contemplating and taking into consideration the critical operating state.

The result of the optimization method, that is to say for example the design of the multimodal energy system and the target value, is denoted by the reference sign 6. The result obtained can be the structure of the multimodal energy system. Furthermore, a value that is as optimum as possible for the target function, for example the operating costs of the multimodal energy system, the carbon dioxide emission of the multimodal energy system and/or the primary energy use of the multimodal energy system, is provided.

In some embodiments, the method synergistically combines at least two essential technical effects. First, the multimodal energy system has a resilience with reference to the at least one critical operating state, in particular with reference to a plurality of critical operating states. Second, the multimodal energy system is designed in as optimum a fashion as possible in respect of its resilience, so that this optimum results in synergies between a normal mode of the multimodal energy system and the mode thereof when a critical operating state is present, for example. Subsequent intervention by providing redundancies is advantageously no longer necessary.

The processes or method steps described above, in particular the optimization method, can be implemented by using instructions available on computer-readable storage media or in volatile computer memories (referred to collectively as computer-readable memories below). Computer-readable memories are for example volatile memories such as caches, buffers, and/or RAM and also nonvolatile memories such as removable data carriers or hard disks. The functions or method steps described above can be available in the form of at least one set of instructions in or on a computer-readable memory. The functions or method steps are not tied to one particular set of instructions or to one particular form of sets of instructions or to one particular storage medium or to one particular processor or to particular execution schemes and can be executed by software, firmware, microcode, hardware, processors or integrated circuits operating on their own or in any combination. A wide variety of processing strategies can be used, for example serial processing by a single processor, multiprocessing, multitasking or parallel processing.

The instructions can be stored in local memories, but it is also possible for the instructions to be stored on a remote system and to be accessed via a network, for example by means of a computer cloud, in particular MindSphere. The term computing apparatus, as used here, covers processors and processing means in the broadest sense, for example servers, general purpose processors, graphics integrated circuits (ASICs), programmable logic circuits such as FPGAs, discrete analog or digital circuits and any combinations of these, including all other processing means known to a person skilled in the art or developed in future. Processors can consist of one or more apparatuses. If a processor consists of multiple apparatuses, these can be configured for the parallel or sequential processing of instructions.

Although the teachings herein have been illustrated and described more specifically in detail by means of the exemplary embodiments, the scope of the teaching is not limited by disclosed examples. Other variations can be derived therefrom by a person skilled in the art without departing from the scope of the disclosure.

What is claimed is:

1. A method for designing a multimodal energy system having a plurality of components, the method comprising:
providing a first set of parameters;
stipulating a second set of secondary conditions;
stipulating a target function;
defining a
critical operating state of the multimodal energy system; and
extremalizing the target function on the basis of the first set of parameters, the second set of secondary conditions, and the critical operating state using an optimization method.

2. The method as claimed in claim 1, further comprising using the critical operating state to define at least one of: the first set of parameters, the second set of secondary conditions, or the target function.

3. The method as claimed in claim 1 wherein the first set of parameters includes at least one of: an energy price, load profile, weather data, or a generability of renewable energies.

4. The method as claimed in claim 1, wherein:
the parameters vary over time; and
the optimization method depends on time and considers at least a first period over one year.

5. The method as claimed in claim 1, wherein the target function includes at least one of: an operating cost of the multimodal energy system, carbon dioxide emission of the multimodal energy system, or primary energy use of the multimodal energy system.

6. The method as claimed in claim 1, wherein the critical operating state comprises at least one of: a power failure, a heat failure, a cold failure, a failure of an energy transfer line, or failure of a component of the multimodal energy system.

7. The method as claimed in claim 1, further comprising using parameters characterizing the critical operating state.

8. The method as claimed in claim 7, wherein the characterizing parameters includes at least one of: weather data, an availability of energy transfer lines, an availability of renewable energy generation, a minimum capacity of an energy store, or a proportional energy requirement in relation to an energy peak load.

9. The method as claimed in claim 1, further comprising considering a plurality of critical operating states using the optimization method when extremalizing the target function;
wherein the critical operating states are weighted based on frequency or relevance.

10. The method as claimed in claim 1, further comprising using monitoring data of a comparable multimodal energy system for stipulating the at least one critical operating state.

11. The method as claimed in claim 10, further comprising using the monitoring data to ascertain a plurality of critical operating states;
wherein a subset of the ascertained critical operating states s stipulated based on frequency of occurrence is considered by the optimization method.

12. The method as claimed in claim 10, wherein a computer cloud provides the monitoring data.

13-15. (canceled)
